(19) United States
(12) Patent Application Publication
(10) Pub. No.: US 2024/0211877 A1
(43) Pub. Date: Jun. 27, 2024

(54) ITEM MANAGEMENT SYSTEM, DATA GENERATION METHOD, AND INFORMATION PROCESSING APPARATUS

(71) Applicant: CANON KABUSHIKI KAISHA, Tokyo (JP)

(72) Inventor: YASUHIRO TOMIOKA, Shizuoka (JP)

(21) Appl. No.: 18/586,895

(22) Filed: Feb. 26, 2024

Related U.S. Application Data
(63) Continuation of application No. PCT/JP2022/025035, filed on Jun. 23, 2022.

(30) Foreign Application Priority Data
Sep. 7, 2021 (JP) 2021-145715

(51) Int. Cl. G06Q 10/087; G06K 7/10; G06Q 10/02

(52) U.S. Cl. CPC G06Q 10/087; G06K 7/10099; G06Q 10/02

(57) ABSTRACT

There is provided an item management system including: first wireless devices installed in respective areas; a second wireless device attached to an item; third wireless devices carried by respective users; at least one reading apparatus capable of reading identification information from a wireless device; a history obtaining unit that obtains a history of positions of the item based on results of reading of identification information from the first and second wireless devices, and a history of movement of each user based on results of reading of identification information from the first and third wireless devices; and a generation unit that generates actual utilization data associating the item with a user who has utilized the item based on comparison between the history of positions of the item and the history of movement of one or more users.

### CROSS-REFERENCE TO RELATED APPLICATIONS

This application is a Continuation of International Patent Application No. PCT/JP2022/025035, filed Jun. 23, 2022, which claims the benefit of Japanese Patent Application No. 2021-145715, filed Sep. 7, 2021, both of which are hereby incorporated by reference herein in their entirety.

### BACKGROUND OF THE INVENTION

### Field of the Invention

The present disclosure relates to an item management system, a data generation method, and an information processing apparatus.

### Background Art

In general, various equipment (for example, vehicles or machines) are utilized at factories and sites of construction work. In order to formulate appropriate work plans, manage work progress, and secure safety of the work, it is important to accurately know actual utilization, that is, information regarding who utilized which equipment. Conventionally, for the purpose of keeping records of such information, for example, an operation to enter information such as user name and usage time into a ledger has been performed when lending and returning a key required to utilize equipment. However, the way to manually enter information into a ledger sometimes caused a situation where records do not match the facts due to inaccurate entries or forgotten entries, for example.

Patent Literature 1 discloses a technology in which an IC tag is mounted on a key for unlocking and locking a storage that stores items, and a history of lending the key is recorded based on information read from the IC tag when lending and returning the key.

### CITATION LIST

### Patent Literature

PTL 1: Japanese Patent No. 6762552

However, the history recorded by the technology disclosed by Patent Literature 1 indicates from which time and to which time a user possessed the key, and does not indicate when and who utilized an item that becomes available using the key. Such a technology is imperfect in terms of keeping accurate records regarding utilization of items because, even if a key that has been lent is handed over to another user, the fact cannot be recognized, for example.

In light of the foregoing, the present invention aims at realizing a mechanism for keeping highly accurate records regarding utilization of items.

### SUMMARY OF THE INVENTION

According to an aspect, there is provided an item management system including: a plurality of first wireless devices installed in a plurality of areas, respectively; a second wireless device attached to an item; a plurality of third wireless devices carried by a plurality of users, respectively; at least one reading apparatus that is capable of reading, from a wireless device, identification information stored in the wireless device; a history obtaining unit configured to obtain a history of positions of the item based on results of reading of identification information from the first wireless devices and the second wireless device by the at least one reading apparatus, and obtain a history of movement of each user based on results of reading of identification information from the first wireless devices and the third wireless device by the at least one reading apparatus; and a generation unit configured to generate actual utilization data associating the item with a user who has utilized the item based on comparison between the history of positions of the item and the history of movement of one or more users. A corresponding method and an information processing apparatus are also provided.

Further features of the present invention will become apparent from the following description of exemplary embodiments with reference to the attached drawings.

### BRIEF DESCRIPTION OF THE DRAWINGS

FIG. 1 is a schematic view illustrating an example of a configuration of an item management system according to an embodiment.

FIG. 2 is a block diagram illustrating an example of a configuration of a tag reader according to an embodiment.

FIG. 3 is a block diagram illustrating an example of a configuration of a management server according to an embodiment.

FIG. 4A is an explanatory diagram illustrating an example of a configuration of an item table according to an embodiment.

FIG. 4B is an explanatory diagram illustrating an example of a configuration of an area table according to an embodiment.

FIG. 5A is an explanatory diagram illustrating an example of a configuration of a reader table according to an embodiment.

FIG. 5B is an explanatory diagram illustrating an example of a configuration of a user table according to an embodiment.

FIG. 5C is an explanatory diagram illustrating an example of a configuration of a reading result table according to the first embodiment.

FIG. 6 is an explanatory diagram for explaining obtainment of a position history of an item and movement histories of users.

FIG. 7A is an explanatory diagram illustrating an example of a configuration of a reservation table according to an embodiment.

FIG. 7B is an explanatory diagram illustrating an example of a configuration of an actual utilization table according to an embodiment.

FIG. 8 is an explanatory diagram for explaining decision of actual utilization based on comparison of histories according to a first practical example.

FIG. 9 is an explanatory diagram for explaining decision of actual utilization based on comparison of histories according to a second practical example.

FIG. 10 is an explanatory diagram for explaining decision of actual utilization based on comparison of histories according to a third practical example.

FIG. 11 is a flowchart illustrating an example of a flow of position estimation processing according to an embodiment.

FIG. 12 is a flowchart illustrating an example of a flow of history obtaining processing according to an embodiment.

FIG. 13 is a flowchart illustrating a first example of a flow of actual utilization generation processing according to an embodiment.

FIG. 14 is a flowchart illustrating a second example of a flow of actual utilization generation processing according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <1. System Overview>

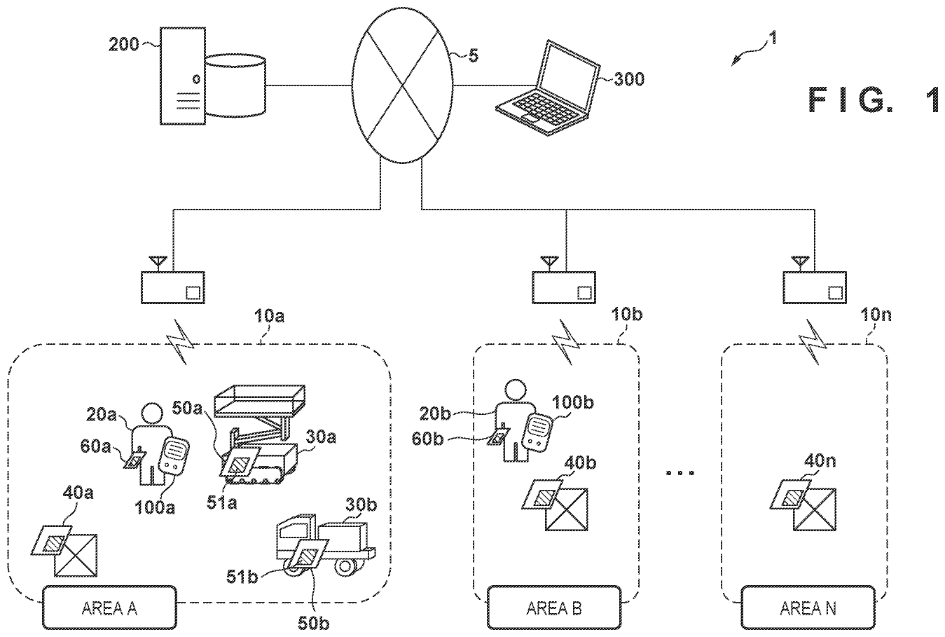

FIG. 1 is a schematic view illustrating an example of a configuration of an item management system 1 according to an embodiment. The item management system 1 is a system for managing statuses of item utilization by users. In the item management system 1, any types of items may be utilized by users, and the items may be non-living objects (for example, machines, equipment, tools, materials, consumable goods, components, vehicles, or robots) or living objects (for example, animals or plants).

In the item management system 1, the space in which each user may act is segmented into a plurality of areas 10a to 10n. There are a user 20a, and items 30a and 30b in the area 10a. There is a user 20b in the area 10b. The users 20a and 20b can freely move across the plurality of areas 10a to 10n.

The item management system 1 makes use of wireless devices, which are also referred to as tags, for the purpose of item management. In the present embodiment, the item management system 1 includes three types of tags. A first type of tags (first wireless devices) are position tags installed in respective areas 10a to 10n. A second type of tags (second wireless devices) are item tags which are attached to respective items managed in the item management system 1. A third type of tags (third wireless devices) are user tags carried by users.

In the example of FIG. 1, position tags 40a to 40n are installed in the areas 10a to 10n, respectively. The installation position of each of the position tags 40a to 40n may be fixed or can be changed. When an area itself moves (for example, a work-site moves), the corresponding position tag may be relocated in conjunction with the movement of the area. Item tags 50a and 50b are attached to the items 30a and 30b, respectively. Each item tag moves as a corresponding item moves. The user 20a carries a user tag 60a. The user 20b carries a user tag 60b. The user tags 60a and 60b may be IC card-type devices such as employee ID cards or admission cards, for example. Note that, in this specification, the expression that a user carries a certain target should broadly comprehend various modes in which the user moves together with the target (for example, moves in a state where he or she holds or wears the target, etc.).

Note that, in the following descriptions, the areas 10a to 10n are collectively referred to as areas 10 by omitting the trailing letter from the reference signs when they do not need to be distinguished from each other. The same applies to the items 30 (items 30a, 30b), the position tags 40 (40a to 40n), the item tags 50 (item tags 50a, 50b), and the user tags 60 (user tags 60a, 60b), as well as any other elements. The number of users 20 and the number of items 30 that exist in the item management system 1 are not limited to the example illustrated in FIG. 1 but may be any numbers.

In the present embodiment, each of the tags such as the position tags 40, the item tags 50, and the user tags 60 is assumed to be a passive-type radio frequency identification (RFID) tag (a passive tag). A passive tag is composed of: a small integrated circuit (IC) chip with an embedded memory; and an antenna, and has identification information for identifying the tag and some other information stored in the memory. In this specification, identification information is simply referred to as an ID, and identification information for identifying a tag is referred to as a tag ID. It should be noted that the tag ID may be considered as information for identifying an object to which the tag is attached. The IC chip of a passive tag operates by utilizing energy of an electromagnetic wave emitted from a tag reader, and modulates the information such as the tag ID and some other information stored in the memory into an information signal to transmit (send back) the information signal from the antenna.

In the example of FIG. 1, the item tags 50a and 50b have specific tag IDs 51a and 51b embedded in the tags, respectively. The tag ID 51 of each item tag 50 is associated with the item 30 to which the item tag 50 is attached in a database described below. Each user tag 60 also has a specific tag ID embedded in the tag. The tag ID of each user tag 60 is associated with the user 20 who carries the user tag 60. Each position tag 40 also has a specific tag ID embedded in the tag. The tag ID of each position tag 40 is associated with the area in which the position tag 40 is installed.

It should be noted that, in another embodiment, each tag may be an active-type RFID tag. If each tag actively (for example, periodically) transmits information to its vicinity by utilizing power from a built-in battery, such a tag may be called a beacon tag. In a further embodiment, each tag may be a wireless device which sends back information in response to a signal from a reader in accordance with Near Field Communication (NFC) protocol or Bluetooth (registered trademark) protocol, for example. Each tag may have any name such as an IC tag, an IC card, or a responder.

The user 20a carries a tag reader 100a in addition to the user tag 60a. The user 20b carries a tag reader 100b in addition to the user tag 60b. In the present embodiment, each tag reader 100 is carried by a user 20 and may move across the plurality of areas 10a to 10n. The item management system 1 includes at least one tag reader 100, a management server 200, and a terminal apparatus 300 as mentioned above. Note that each tag reader 100 is not necessarily associated with a specific user 20. For example, the users 20a and 20b may exchange the tag readers 100a and 100b with each other, and a plurality users 20 may share a smaller number of tag readers 100.

The tag readers 100, the management server 200, and the terminal apparatus 300 are connected to a network 5. The network 5 may be a wired network, a wireless network, or any combination thereof. Examples of the network 5 may include the Internet, an intranet, and a cloud network.

The tag reader 100 is a reading apparatus that is capable of reading, from wireless devices such as RFID tags, information stored in the wireless devices. For example, the tag reader 100 can detect an item 30 by reading the tag ID 51 from the item tag 50 attached to the item 30. The tag reader 100 performs reading periodically or in response to a certain trigger such as a user operation, and transmits a tag reading result to the management server 200. The tag reader 100 may be capable of communicating with the management server 200 directly or indirectly via a certain relay apparatus (for example, a PC or a smartphone carried by a user 20). An example of a particular configuration of the tag reader 100 will be further described below.

The management server 200 is an information processing apparatus that tracks positions of the users 20 and the items 30, and records statuses of utilization of the items 30 by the users 20 in a database. The management server 200 may be implemented as an application server, a database server, or a cloud server by using a high-end general-purpose computer, for example. An example of a particular configuration of the management server 200 will be further described below.

Though a single management server 200 is illustrated in FIG. 1, the functions of the management server 200, which will be described in detail below, may be provided by a single apparatus or by physically-separate multiple apparatuses which operate in conjunction with each other. In addition, though an example where the management server 200 maintains a database will be described in the present embodiment, an apparatus other than the management server 200 may maintain a part or all of the database. For example, a part of data may be maintained by the wireless device, the tag reader 100 or the terminal apparatus 300.

The terminal apparatus 300 is used by a user 20 or a manager of the item management system 1. The terminal apparatus 300 may be a general-purpose terminal such as a personal computer (PC) or a smartphone, or a dedicated terminal specialized for an item management purpose. The terminal apparatus 300 may be portable or stationary. The terminal apparatus 300 typically comprises an input device that receives user inputs, a communication interface that communicates with other apparatuses (for example, the management server 200), and a display device that displays information. As an example, the terminal apparatus 300 is used by a user 20 when registering a utilization reservation of an item 30 on the management server 200. As another example, the terminal apparatus 300 is used by a manager when browsing actual utilization data described below that may be provided from the management server 200.

It should be noted that, though FIG. 1 illustrates the tag reader 100 and the terminal apparatus 300 as separate apparatuses, there may be provided an integrated apparatus which has both of functionalities of the tag reader 100 and the terminal apparatus 300. Moreover, the terminal apparatus 300 may be carried by a user 20 and may relay communication between the tag reader 100 and the management server 200. Furthermore, the functions of the management server 200 described in the present embodiment may be realized within the terminal apparatus 300.

### <2. Configuration Example of Tag Reader>

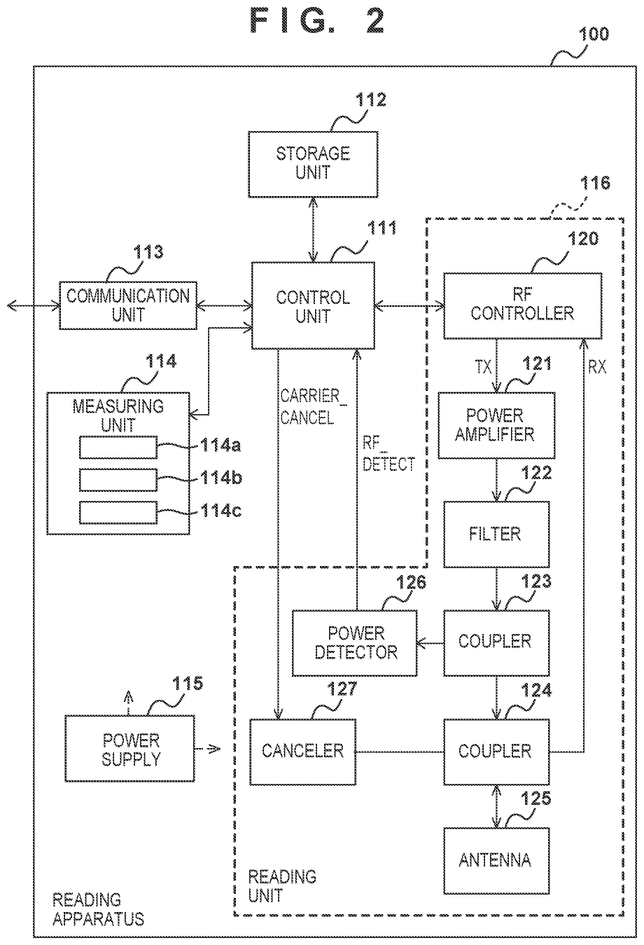

FIG. 2 is a block diagram illustrating an example of a configuration of the tag reader 100 according to an embodiment. With reference to FIG. 2, the tag reader 100 comprises a control unit 111, a storage unit 112, a communication unit 113, a measuring unit 114, a power supply 115, and a reading unit 116.

The control unit 111 consists of a memory to store computer programs, and one or more processors (for example, CPUs or microcontrollers) to execute the computer programs. The control unit 111 controls overall functionality of the tag reader 100 described in this specification. For example, the control unit 111 causes the reading unit 116 to attempt reading from an RFID tag within a tag reading range, and causes the storage unit 112 to temporarily store the read information and the time of the reading as reading result data. In parallel to the reading from RFID tags, the control unit 111 also causes the measuring unit 114 to measure the position of the tag reader 100, and the storage unit 112 to store a measurement result. Then, the control unit 111 transmits, to the management server 200 via the communication unit 113, the reading result data and the measurement result data stored in the storage unit 112 together with reader identification information (also referred to as a reader ID) that identifies the apparatus itself.

The storage unit 112 may include any kind of storage medium such as a semiconductor memory (a read only memory (ROM), a random access memory (RAM), or the like), an optical disk, or a magnetic disk, for example. In the present embodiment, the storage unit 112 stores the above-described reading result data, measurement result data, and the reader ID of the tag reader 100.

The communication unit 113 is a communication interface for the tag reader 100 to communicate with the management server 200. For example, the communication unit 113 may be a wireless local area network (WLAN) interface that communicates with a WLAN access point, or a cellular communication interface that communicates with a cellular base station. Alternatively, the communication unit 113 may be a connection interface (e.g. a Bluetooth (registered trademark) interface or a universal serial bus (USB) interface) for connection with a relay apparatus.

The measuring unit 114 is a unit that is capable of measuring a position of the tag reader 100. In the present embodiment, the measuring unit 114 uses the self-localization technique, also referred to as pedestrian dead reckoning (PDR) to measure an amount of relative movement of the tag reader 100 from a certain reference position, and outputs the measured amount of movement to the control unit 111. The reference position of measurement of the amount of relative movement may be, for example, the position of the tag reader 100 at the time when the tag reader 100 is activated. The amount of relative movement of the tag reader 100 may be treated as a relative position. For example, the measuring unit 114 includes three-axis acceleration sensor 114a, gyro sensor 114b, and geomagnetic sensor 114c. The three-axis acceleration sensor 114a measures acceleration applied to the tag reader 100 in the device coordinate system that is specific to the tag reader 100, and outputs first sensor data. The gyro sensor 114b measures an angular speed of the tag reader 100, that is, a change in attitude of the tag reader, to output second sensor data. The geomagnetic sensor 114c measures an orientation of the tag reader 100 in the real space, and outputs third sensor data. The measuring unit 114 can measure the amount of relative movement of the tag reader 100 based on these pieces of sensor data by converting the direction of the acceleration of the tag reader 100 into a direction in a coordinate system of the real space to integrate the converted acceleration. The amount of relative movement of the tag reader 100 output from the measuring unit 114 to the control unit 111 may be a two-dimensional vector in a horizontal plane or a three-dimensional vector that includes a component of height direction as well.

As described below, in the present embodiment, the positional coordinates of the installation position of each position tag 40 is known and registered in a database. Therefore, the current (positional coordinates of) absolute position of the tag reader 100 can be estimated based on the amount of relative movement of the tag reader 100 from the time point where it detected a position tag 40 to the current time point, and the known positional coordinates of that position tag 40. In the present embodiment, an example where the management server 200 estimates an absolute position of the tag reader 100 is mainly described, however, the control unit 111 or the measuring unit 114 of the tag reader 100 may access the database to estimate the absolute position of the tag reader 100. In another embodiment, the measuring unit 114 may measure the current geographical position of the tag reader 100 by utilizing the global positioning system (GPS). In yet another embodiment, the measuring unit 114 may perform base station positioning or wireless LAN positioning in which the current position is estimated by utilizing known positional coordinates of a base station or a wireless LAN access point to which the apparatus is connected.

It should be noted that, though FIG. 2 illustrates an example where the tag reader 100 includes the measuring unit 114, the measuring unit 114 may be included in an external device that is capable of communicating with the tag reader 100 and is carried by the user along with the tag reader 100. In that case, the tag reader 100 receives, from the external device, movement amount information indicating an amount of relative movement measured by the measuring unit 114.

The power supply 115 includes a battery and a DC-DC converter, and supplies power for operating electronic circuits of the control unit 111, the storage unit 112, the communication unit 113, the measuring unit 114 and the reading unit 116 of the tag reader 100. The battery may include a primary cell, or a rechargeable secondary cell. Although not illustrated in the figure, the tag reader 100 may have a connection terminal for connecting the tag reader 100 to an external power source for recharging the power supply 115.

The reading unit 116 is a unit that is capable of reading, from each of the tags such as the position tags 40, the item tags 50, and the user tags 60 described above, information stored in the tag. With reference to FIG. 2, the reading unit 116 includes an RF controller 120, a power amplifier 121, a filter 122, a first coupler 123, a second coupler 124, an antenna 125, a power detector 126, and a canceler 127. The RF controller 120 outputs a transmission signal (for example, a signal modulated in the UHF band) from a TX terminal to the power amplifier 121 in accordance with control by the control unit 111. The power amplifier 121 amplifies the transmission signal input from the RF controller 120 to output it to the filter 122. The amplification rate of the transmission signal here may be controllable in variable manner, and a higher amplification rate will enhance an output strength of an electromagnetic wave emitted from the tag reader 100. The filter 122 may be a low-pass filter, for example, and filters out unnecessary frequency components from the transmission signal amplified by the power amplifier 121. The first coupler 123 distributes the transmission signal that has passed the filter 122 to the coupler 124 and the power detector 126. The second coupler 124 outputs the transmission signal input from the first coupler 123 to the antenna 125, and outputs a received signal input from the antenna 125 to the RF controller 120. The antenna 125 transmits the transmission signal input from the coupler 124 to the air as an electromagnetic wave. Further, the antenna 125 receives a signal that has been sent back from an RFID tag that exists within the reading range of the tag reader 100 in response to the transmission signal, and outputs the received signal to the coupler 124. As an example, the antenna 125 may be an omnidirectional antenna. As another example, the antenna 125 may be a directional antenna of which beam direction can be variably controlled. The power detector 126 detects a power level of the signal input from the first coupler 123, and outputs a signal ‘RF_DETECT’ indicative of the detected power level to the control unit 111. The canceler 127 receives a signal ‘CARRIER_CANCEL’ indicative of a power level of a carrier from the control unit 111. Then, the canceler 127 extracts an intended signal component of the received signal to be output to an RX terminal of the RF controller 120 by canceling the carrier component of the transmission signal based on the CARRIER_CANCEL. The RF controller 120 demodulates the signal input from the RX terminal to obtain a tag ID and other information sent back from the RFID tag, and outputs the obtained information to the control unit 111. The RF controller 120 also measures a reception level (also referred to as received strength) of the signal input from the RX terminal, and outputs the measurement result to the control unit 111.

In the present embodiment, the reading unit 116 can attempt tag reading periodically (for example, once per second) without requiring any explicit command from a user. Data transmission from the communication unit 113 to the management server 200 can also be performed periodically (for example, every few seconds) or whenever the tag reading is done without requiring any explicit command from a user. The control unit 111 may exclude, from the data to be transmitted, the same record as the most recent record that has already been transmitted in a predetermined time period to omit redundant data transmission and reduce a communication load. When a reception level of a received signal from an RFID tag exceeds a preset minimum detection level, the control unit 111 may determine to have detected the RFID tag, and transmit a reading result data about the detected RFID tag to the management server 200. It should be noted that, in another embodiment, one or both of an attempt of tag reading by the reading unit 116 and data transmission to the management server 200 may be performed in response to a user operation detected via an input device (for example, a button) arranged in the tag reader 100. In a case where the communication unit 113 performs communication with the management server 200 indirectly via a relay apparatus, the data transmission to the management server 200 may be performed only while there is an effective connection between the communication unit 113 and the relay apparatus.

### <3. Configuration Example of Management Server>

### <3-1. Basic Configuration>

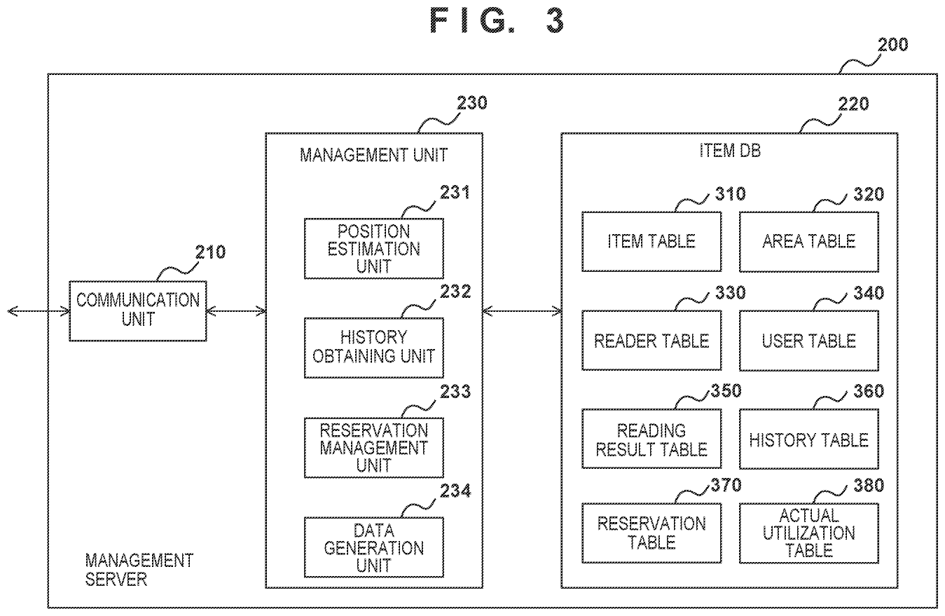

FIG. 3 is a block diagram illustrating an example of a configuration of the management server 200 according to an embodiment. With reference to FIG. 3, the management server 200 comprises a communication unit 210, an item database (DB) 220, and a management unit 230.

The communication unit 210 is a communication interface for the management server 200 to communicate with other apparatuses. The communication unit 210 may be a wired communication interface or a wireless communication interface. In the present embodiment, the communication unit 210 communicates with the tag readers 100 and the terminal apparatus 300. The item DB 220 is a database that stores various information for tracking positions of the users 20 and the items 30 and recognition of statuses of utilization of the items 30. In the present embodiment, the item DB 220 includes an item table 310, an area table 320, a reader table 330, a user table 340, a reading result table 350, a history table 360, a reservation table 370, and an actual utilization table 380. The management unit 230 is a set of software modules that provide management functions for managing data within the item DB 220. The individual software modules can run by one or more processors (not shown) of the management server 200 executing computer programs stored in a memory (not shown). In the present embodiment, the management unit 230 includes a position estimation unit 231. a history obtaining unit 232, a reservation management unit 233, and a data generation unit 234.

### <3-2. Configuration of Master Data>

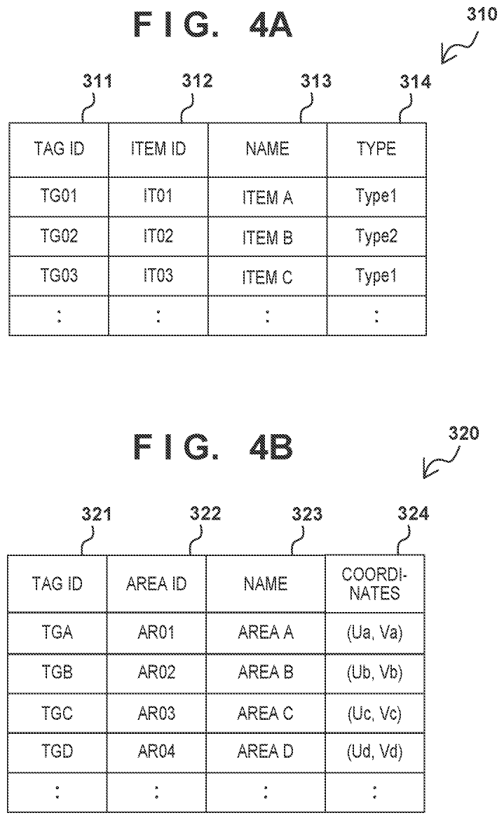

FIGS. 4A and 4B illustrate respective configuration examples of the item table 310 and the area table 320 of the item DB 220.

The item table 310 has four data elements, namely Tag ID 311, Item ID 312, Name 313, and Type 314. Tag ID 311 is identification information that uniquely identifies an item tag 50 attached to each of the items 30 under management of the system. The value of Tag ID 311 is the same as the value of the tag ID stored within the corresponding item tag 50. Item ID 312 is identification information that uniquely identifies each item 30. Name 313 represents a name of each item 30. In the example of FIG. 4A, the items identified by item IDs “IT01”, “IT02”, and “IT03” are given the names of “Item A”, “Item B”, and “Item C”, respectively. Herein. “Item A” may correspond to the item 30a illustrated in FIG. 1, and “Item B” may correspond to the item 30b illustrated in FIG. 1. Type 314 represents a type into which each item 30 is classified. In the example of FIG. 4A, the type of “Item A” and “Item C” is “Type 1”, and the type of “Item B” is “Type 2”. The values of Name 313 and Type 314 of each item 30 are determined by a user, and may be registered in advance via a user interface (UI) provided by the management unit 230.

Alternatively, the values of Name 313 and Type 314 may be stored in item tags 50 as item-related information and read by a tag reader 100. In the latter case, upon initial tag reading from the item tag 50 of each item 30, the management server 200 may receive the values of Name 313 and Type 314 of that item 30 from the tag reader 100, and register them in the item table 310.

The area table 320 has four data elements, namely Tag ID 321, Area ID 322, Name 323, and Coordinates 324. Tag ID 321 is identification information that uniquely identifies the position tag 40 installed in each of the plurality of areas 10. The value of Tag ID 321 is the same as the value of the tag ID stored within the corresponding position tag 40. Area ID 322 is identification information that uniquely identifies each area 10. Name 323 indicates the name of each area 10. In the example in FIG. 4B, the areas identified by area IDs “AR01”, “AR02”, “AR03”, and “AR04” are given the names of “Area A”, “Area B”, “Area C”, and “Area D”, respectively. In practice, these names may be, for example, “Construction Area X”, “Floor Y”, “Warehouse Z”, or the like. Coordinates 324 represent the positional coordinates of the installation positions of the position tags 40 installed in respective areas 10.

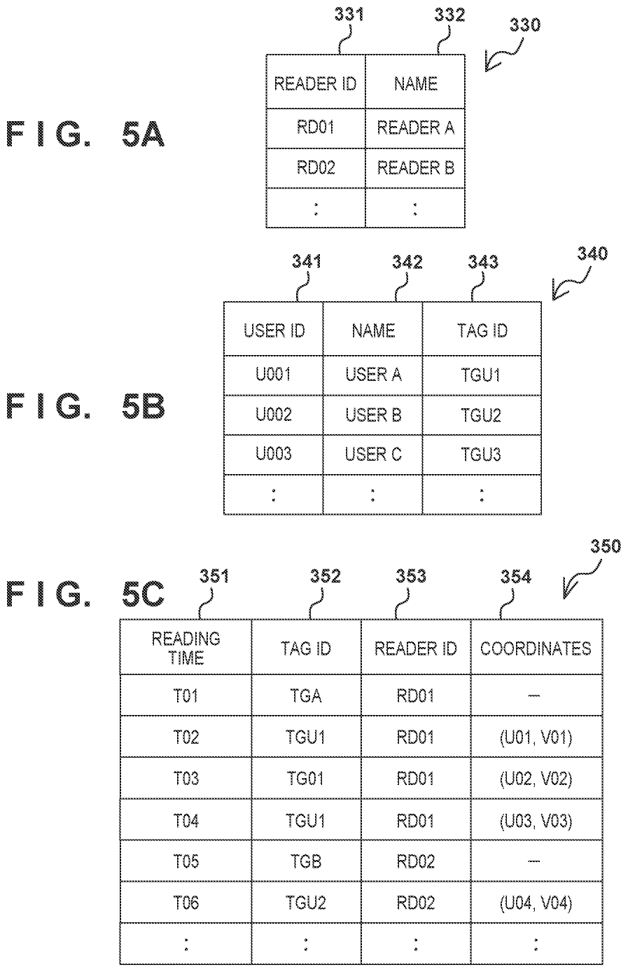

FIGS. 5A and 5B illustrate examples of the configurations of the reader table 330 and the user table 340, respectively.

The reader table 330 has two data elements, namely Reader ID 331 and Name 332. Reader ID 331 is identification information that uniquely identifies each of the tag readers 100 used in the system. Name 332 indicates a name of each tag reader. In the example in FIG. 5A, the tag readers 100 identified by Reader IDs “RD01” and “RD02” are given the names of “Reader A” and “Reader B”, respectively.

The user table 340 has three data elements, namely User ID 341, Name 342, and Tag ID 343. User ID 341 is identification information that uniquely identifies each of the users 20 who utilizes an item 30 in the item management system 1. Name 342 indicates a name of each user. In the example in FIG. 5B, the name of the user 20 identified by User ID “U001” is “User A”, the name of the user 20 identified by User ID “U002” is “User B”, and the name of the user 20 identified by User ID “U003” is “User C”. Tag ID 343 is identification information that uniquely identifies the user tag 60 carried by each user 20. The value of Tag ID 343 is the same as the value of the tag ID stored within the corresponding user tag 60. Although not illustrated in the drawings, the user table 340 may include additional data elements that hold authentication information (e.g., passwords or biometric information) for user authentication performed when logging into the system.

### <3-3. Position Tracking>

The reading result table 350 is a table for storing records of reading result data received from the tag readers 100 (hereinafter, referred to as “reading result records”). FIG. 5C illustrates an example of the configuration of the reading result table 350. The reading result table 350 has four data elements, namely Reading Time 351, Tag ID 352, Reader ID 353, and Coordinates 354. Reading Time 351 indicates the time at which the tag ID for the corresponding reading result record has been read. Tag ID 352 indicates a tag ID that has been read for the corresponding reading result record. Reader ID 353 is identification information that identifies the tag reader 100 that has read the tag for the corresponding reading result record. In the example in FIG. 5C, the first record in the reading result table 350 indicates that the tag reader 100a identified by Reader ID “RD01” read Tag ID “TGA” (e.g., the tag ID of the position tag 40a) at Time “T01”. The second record indicates that the tag reader 100a read Tag ID “TGU1” (e.g., the tag ID of the user tag 60a of the user 20a) at Time “T02”. The third record indicates that the tag reader 100a read a Tag ID “TG01” (e.g., the tag ID of the item tag 50a of the item 30a) at Time “T03”. Coordinates 354 represent the positional coordinates of the point at which the tag reader 100 was present at the point in time when the tag was read.

Upon receiving reading result data for a user tag 60 from a tag reader 100, the position estimation unit 231 estimates the position at which the user 20 associated with the read tag ID was present at the reading time indicated by the reading result data. The position of the user is estimated using the measurement result data received periodically from the tag reader 100. For example, assume that the tag reader 100a read the tag ID of the position tag 40a at Reading Time T01 (a first point in time), and then read the tag ID of the user tag 60a at Reading Time T02 (a second point in time). The amount of relative movement of the tag reader 100a from Reading Time T01 to Reading Time T02 corresponds to a difference in the amount of movement measured by the tag reader 100a at the two points in time, and the position estimation unit 231 can derive this difference based on the measurement result data. Here, the coordinates of the installation position of the position tag 40a installed in the area 10a are known, and are defined in the area table 320. Therefore, the position estimation unit 231 can estimate the position at which the user 20a was present at Reading Time T02 by adding the amount of relative movement of the tag reader 100a from Reading Time T01 to Reading Time T02 to the known positional coordinates of the position tag 40a. The position estimation unit 231 adds the positional coordinates of each user 20 estimated in this manner to the field for Coordinates 354 of the corresponding record in the reading result table 350.

Similarly, upon receiving reading result data for an item tag 50 from a tag reader 100, the position estimation unit 231 estimates the position at which the item 30 associated with the read tag ID was present at the reading time indicated by the reading result data. The position of the item is also estimated using the measurement result data received periodically from the tag reader 100. For example, assume that the tag reader 100a read the tag ID of the position tag 40a at Reading Time T01 (the first point in time), and then read the tag ID of the item tag 50a attached to the item 30a at Reading Time T03 (a third point in time). The amount of relative movement of the tag reader 100a from Reading Time T01 to Reading Time T03 corresponds to a difference in the amount of movement measured by the tag reader 100a at the two points in time, and the position estimation unit 231 can derive this difference based on the measurement result data. Then, the position estimation unit 231 can estimate the position at which the item 30a was present at Reading Time T03 by adding the amount of relative movement of the tag reader 100a from Reading Time T01 to Reading Time T03 to the known positional coordinates of the position tag 40a. The position estimation unit 231 adds the positional coordinates of each item 30 estimated in this manner to the field for Coordinates 354 of the corresponding record in the reading result table 350.

### <3-4. Obtaining History>

The history obtaining unit 232 obtains a history of the position of each item 30 and a history of the movement of each user 20 from the reading result table 350 on a regular basis. For example, the history obtaining unit 232 executes processing for obtaining the history of the position of each item 30 and the history of the movement of each user 20 each time a predefined period has passed, and stores the obtained position histories and movement histories in the history table 360. The predefined period may be any length, such as several hours, half a day, or a day, for example.

More specifically, based on the results of the tag readers 100 reading the tag IDs from the position tags 40 and the item tags 50, the history obtaining unit 232 obtains the position histories of the items 30 to which the item tags 50 are attached. Likewise, based on the results of the tag readers 100 reading the tag IDs of the position tags 40 and the user tags 60, the history obtaining unit 232 obtains the movement histories of the users 20 who carry the user tags 60. In the present embodiment, the position history of each item 30 is data indicating in which area 10 each item 30 has existed in time series. In addition, the movement history of each user 20 is data indicating in which area each user 20 has existed in time series.

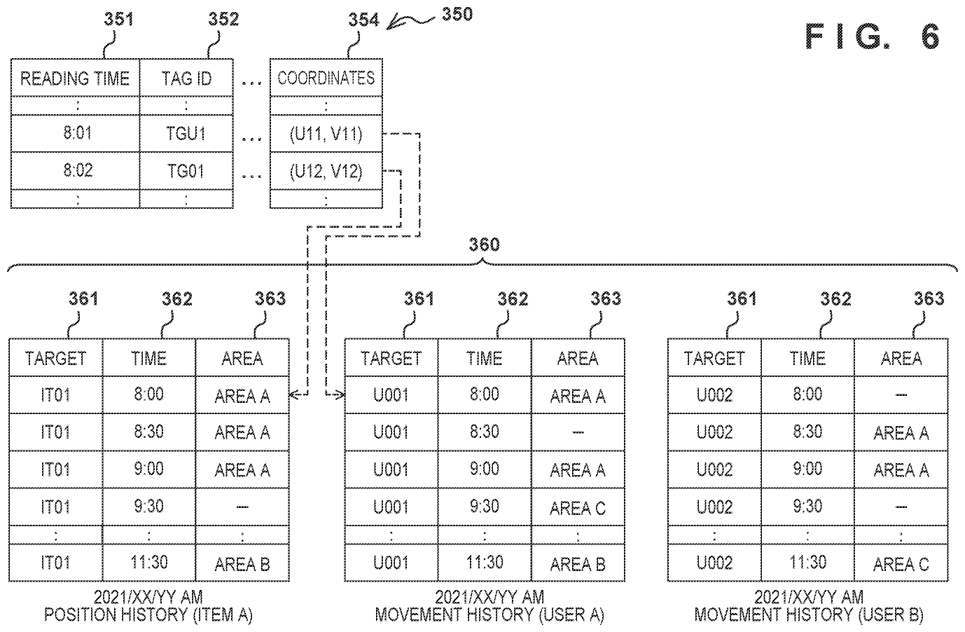

FIG. 6 is an explanatory diagram illustrating the obtainment of the position history and the movement history by the history obtaining unit 232. The upper part of FIG. 6 illustrates some of the content in the reading result table 350 as an example. For example, assume that Tag ID “TGU1” was read from the user tag 60a of the user 20a at 8:01 AM on day Y of month X in 2021, and that the user 20a was estimated to be located at positional coordinates (U11, V11) at that point in time. In addition, assume that Tag ID “TG01” was read from the item tag 50a of the item 30a at 8:02 AM on the same day, and that the item 30a was estimated to be located at positional coordinates (U12, V12) at that point in time.

The lower part of FIG. 6 illustrates an example of the position history of the item 30a (Item A), the movement history of the user 20a (User A), and the movement history of the user 20b (User B) stored in the history table 360 by the history obtaining unit 232. As illustrated in the drawing, the history table 360 has three data elements, namely Target 361, Time 362, and Area 363. Target 361 indicates the item ID of the item 30 or the user ID of the user 20 associated with the corresponding record in the history (hereinafter, referred to as “history record”). Time 362 indicates a representative time (e.g., a start time) for each of segments into which the aforementioned period has been subdivided (each segment having a time length of several minutes, several tens of minutes, or one hour, for example). Area 363 indicates in which area 10 the item 30 or user 20 identified by the value of Target 361 in the corresponding segment was present, using the area ID or name of the area 10.

For example, the history obtaining unit 232 extracts reading result records for the item 30a indicating reading times belonging to a certain segment from the reading result table 350. If there is no corresponding reading result record, the history obtaining unit 232 may determine that the position of the item 30a in that segment is unknown, and generate a history record in which Area 363 is blank. If at least one corresponding reading result record has been extracted, the history obtaining unit 232 determines, for example, to which area 10 each of the positional coordinates indicated by the reading result record belongs. Then, the history obtaining unit 232 may determine, for example, that the area 10 corresponding to the largest number of reading result records is the area 10 in which the item 30a existed in that segment. In the example in FIG. 6, the coordinates (U12, V12) of the estimated position of the item 30a at 8:02 AM belong to Area A, and it is therefore determined that the item 30a (Item A) existed in Area Ain the segment from 8:00 to 8:30, as indicated in the lower-left. Likewise, the coordinates (U11, V11) of the estimated position of the user 20a at 8:01 AM belong to Area A, and it is therefore determined that the user 20a (User A) existed in Area A in the segment from 8:00 to 8:30, as indicated in the lower-center.

To which area 10 a given set of positional coordinates belongs may be determined, for example, based on a distance between those positional coordinates and the known coordinates of the position tag 40 in each area 10. As an example, if the position tag 40a among the plurality of position tags 40 is closest to the positional coordinates (U12, V12), the positional coordinates (U12, V12) may be determined to belong to the area 10a associated with the position tag 40a. As another example, if the radius of each area 10 is defined in advance in the area table 320, and the positional coordinates are within a circle defined by the positional coordinates of the position tag 40 and the radius of the area 10, the positional coordinates may be determined to belong to that area 10. As yet another example, information representing the boundaries of each area 10 (e.g., the coordinates of vertices of the boundaries of a polygon) may be defined in advance in the area table 320. In this case, if the positional coordinates are within the defined boundaries of the area 10, the positional coordinates may be determined to belong to that area 10.

Note that which area 10 the user 20 or item 30 has existed may be determined without relying on the positional coordinates of those targets. For example, assume that a position tag 40 is installed at a gate of each area 10, and the tag readers 100 carried by the users 20 always read the tag ID of the position tag 40 when entering and exiting each area 10. In this case, the history obtaining unit 232 can determine the area 10 in which a user 20 or an item 30 has existed from the history of the detection of the position tag 40 (e.g., that the target is present in an area 10 during a period from when the target enters that area 10 to when the target leaves that area 10).

### <3-5. Managing Utilization Reservations>

The reservation management unit 233 manages reservation data indicating reservations for utilization of the items 30 in the reservation table 370 of the item DB 220. For example, the reservation management unit 233 may provide a UI for accepting registration of reservations (e.g., a reservation registration screen) to a user 20 or an administrator through the terminal apparatus 300, and register the reservation data entered through the provided UI in the reservation table 370. The reservation management unit 233 may provide a UI that enables viewing, modification, or deletion of registered reservation data to the user 20 or the administrator through the terminal apparatus 300.

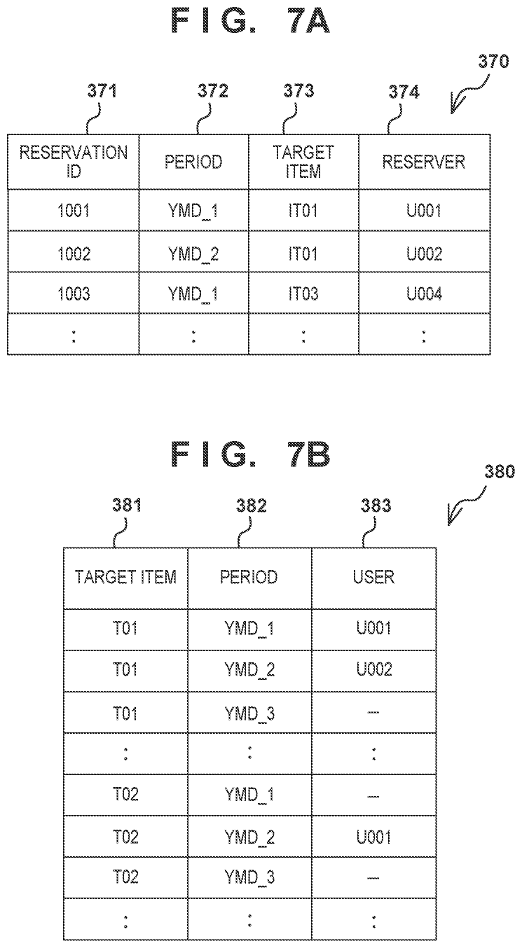

FIG. 7A illustrates an example of the configuration of the reservation table 370 in the item DB 220. The reservation table 370 has four data elements, namely Reservation ID 371, Period 372, Target Item 373, and Reserver 374. Reservation ID 371 is identification information that uniquely identifies each record in the reservation table 370 (hereinafter, referred to as “reservation record”). Period 372 indicates to which period each reservation record applies. Target Item 373 indicates to which item 30 each reservation record applies, using the item ID of that item 30. Reserver 374 indicates, for each reservation record, the user 20 who is scheduled to utilize the item 30 indicated by Target Item 373 during the period indicated by Period 372, using the user ID of that user 20. Such a UI that enables the registration, viewing, modification, or deletion of reservation data may be configured using any method known to those skilled in the art, and will therefore not be described here.

### <3-6. Generating Actual Utilization Data>

Based on a comparison between the position history of an item 30 stored in the history table 360 and a movement history of one or more users 20, the data generation unit 234 generates actual utilization data that associates the item 30 with a user 20 who has utilized that item 30. For example, each time a predefined period passes, the data generation unit 234 generates the actual utilization data for each item 30 in the period that has passed, and stores the generated actual utilization data in the actual utilization table 380. FIG. 7B illustrates an example of the configuration of the actual utilization table 380 in the item DB 220. The actual utilization table 380 has three data elements, namely Target Item 381, Period 382, and User 383. Each record in the actual utilization table 380 indicates which user 20 utilized each item 30 in each period based on a combination of the values in Target Item 381, Period 382, and User 383. The data generation unit 234 may enable a user 20 or an administrator to view the generated actual utilization data through the terminal apparatus 300, for example. The data generation unit 234 may also output the actual utilization data for a specific period to a data file and transmit the file to another apparatus.

In the present embodiment, the data generation unit 234 may decide that the user 20 who has the movement history having the highest correlation with the position history of each item 30 (hereinafter, referred to as “target item”) in a given period (hereinafter, referred to as “target period”) is a user who has utilized the target item in the target period. For example, for each user, the data generation unit 234 determines the degree of coincidence between areas in which the target item has existed in the target period on a per time frame basis and areas in which that user has existed in the target period on a per time frame basis. The data generation unit 234 then decides, based on the degree of coincidence determined for each user, which user has utilized the target item in the target period. At this time, the correlation between the position history and the movement history may be evaluated as being higher as the determined degree of coincidence increases. Accordingly, in principle, the user indicating the highest degree of coincidence for the histories is decided on as the user who has utilized the target item in the target period.

The data generation unit 234 may determine, for each user, the degree of non-coincidence between areas in which the target item has existed in the target period on a per time frame basis and areas in which that user has existed in the target period on a per time frame basis. The data generation unit 234 may then decide that a user for which the degree of non-coincidence is determined to exceed a criterion value is not a user who has utilized the target item in the target period, regardless of the degree of coincidence between the histories. In other words, the correlation between the position history and the movement history may be evaluated as being lower as the determined degree of non-coincidence increases. The criterion value compared to the degree of non-coincidence may be, for example, a predefined fixed value, or may be a product obtained by multiplying a given coefficient α (0<α <1) with the degree of coincidence.

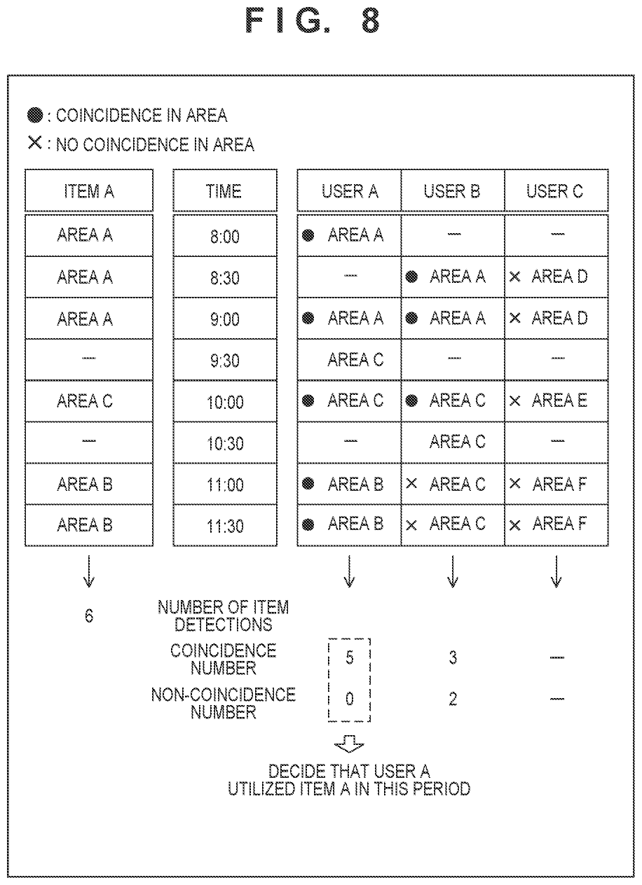

FIG. 8 is an explanatory diagram for explaining a decision on actual utilization based on a comparison of histories according to a first practical example. Here, the target item is Item A. A target period from 8 AM to noon on a given date is divided into a total of eight segments, and the start times of those segments are indicated in the second column from the left in FIG. 8 (hereinafter, referred to as “time column”). The position history of Item A that can be obtained from the history table 360 is indicated to the left of the time column, and Item A is determined to have been present in Area A in the first three segments of the target period, in Area C in the fifth segment, and in Area B in the seventh and eighth segments. The movement histories of User A, User B, and User C that can be obtained from the history table 360 are indicated to the right of the time column.

As primary filtering of candidate users, the data generation unit 234 identifies one or more users for which an area in the position history of the target item is included in their movement history, and compares the histories for those users. If the number of areas included in the position history (the three areas, namely Areas A, B, and C, in the example of FIG. 8) is large, only a predetermined number of areas from the number appearing in the position history may be used for primary filtering of candidate users. In the example in FIG. 8, the movement history of User C does not include any areas included in the position history of Item A, and thus User C is excluded from the history comparison. Narrowing down the candidate users through such primary filtering before the history comparison makes it possible to reduce the processing time required for deciding on the actual utilization and lighten the computational load.

The lower part of FIG. 8 illustrates several statistical values aggregated by the data generation unit 234. “Number of item detections” is the number of times the target item has been detected by the tag reader 100 (the number of times per segment). Here, Item A, which is the target item, has been detected in six of the eight segments, and thus the number of item detections is 6. “Coincidence number” is the number of segments in which there is coincidence in areas, between the position history of the target item and the movement history of each candidate user. User A is detected in the same area as the target item in the five segments indicated by solid circles in the drawing, and thus the coincidence number for User A is 5. User B is detected in the same area as the target item in the three segments indicated by solid circles in the drawing, and thus the coincidence number for User B is 3. “Non-coincidence number” is the number of segments in which there is no coincidence in areas, between the position history of the target item and the movement history of each candidate user. A segment in which at least one area is blank in the position history and the movement history may be ignored in the aggregation. For User A, there is no segment having non-coincidence for an area, and thus the non-coincidence number for User A is zero. User B is detected in a different area from the target item in the two segments indicated by an X in the drawing, and thus the non-coincidence number for User B is 2. Here, the number of item detections for the target item is defined as T; the coincidence number for a candidate user K, as rₖ; the non-coincidence number, as sₖ; the degree of coincidence Rₖ=rₖ/T; and the degree of non-coincidence Sₖ=sₖ/T. Such being the case, in the example in FIG. 8, a degree of coincidence R_{A} and a degree of non-coincidence S_{A} of User A, and a degree of coincidence R_{B} and a degree of non-coincidence SB of User B, can be calculated as follows:

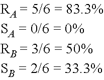

In this case, the degree of coincidence of User A is the highest among the candidate users and the degree of non-coincidence of User A is lower than the criterion value (e.g., 25%, when the coefficient α=0.3), and thus the data generation unit 234 may decide that Item A has been utilized by User A in the target period.

The data generation unit 234 may further generate the actual utilization data based on the reservation data held in the reservation table 370. Taking the reservation data into account when deciding on the actual utilization makes it possible to reduce the computational load by avoiding cross-comparisons among a large number of histories, or alternatively, makes a highly-accurate determination possible when equivalent correlations are indicated for a plurality of users 20.

As an example, when the reservation data indicates that a specific user 20 is scheduled to utilize the item 30 in the target period, the data generation unit 234 may first compare the movement history of the specific user 20 to the position history of the item 30. If the correlation between these histories satisfies a predetermined criterion, it may be decided that the specific user 20 has utilized the item 30 in the target period without taking into account the movement histories of other users 20. Here, the predetermined criterion may include that the degree of coincidence between the aforementioned histories exceeds a given criterion value, and may further include that the degree of non-coincidence between the histories does not exceed another criterion value. A user 20 registered as a user of an item 30 is highly likely to actually utilize that item 30 in accordance with a reservation. Accordingly, such a method makes it possible to avoid, in many cases, the primary filtering of candidate users, as well as the calculation and mutual comparison of the statistical values for the plurality of users 20. If the correlation between the movement history of the user 20 who is the reserver and the position history of the target item does not satisfy the criteria, the user 20 who has utilized the target item may be decided on after temporary filtering on the remaining users 20 and the calculation and mutual comparison of the statistical values for the candidate users.

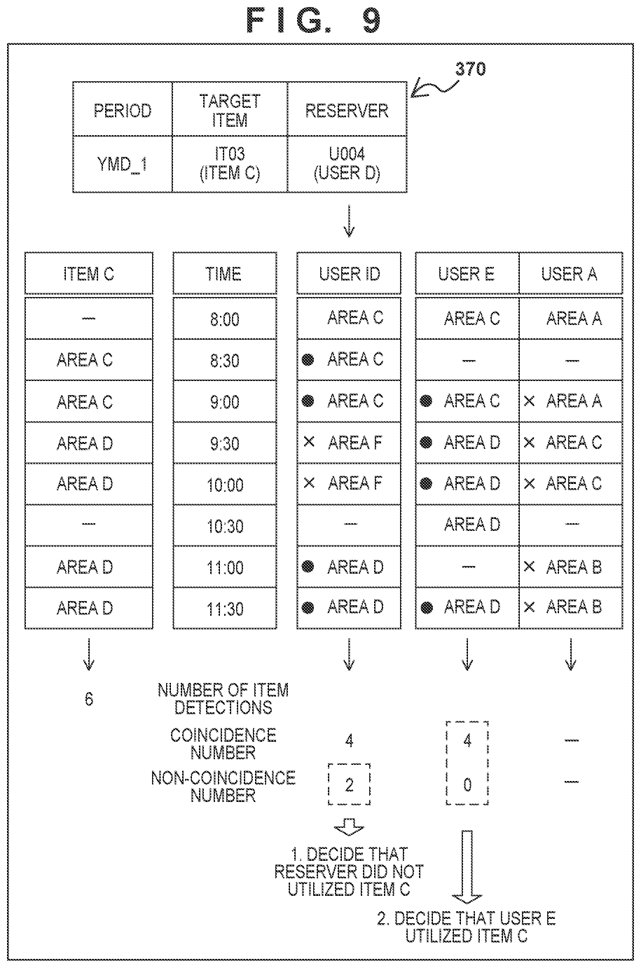

FIG. 9 is an explanatory diagram for explaining a decision on actual utilization based on a comparison of histories according to a second practical example. Here, the target item is Item C. A target period from 8 AM to noon on a given date (YMD_1) is divided into a total of eight segments, and the start times of those segments are indicated in the time column. The position history of Item C is indicated to the left of the time column, and the movement histories of User D, User E, and User A are indicated to the right of the time column.

The reservation data registered in the reservation table is partially indicated in the upper part of FIG. 9, and this reservation data indicates that Item C is scheduled to be utilized by User D during the target period. Accordingly, the data generation unit 234 first compares the movement history of User D, who was the reserver, with the position history of Item C. As indicated in the lower part of FIG. 9, in this example, aggregation is performed such that the number of item detections T=6, the coincidence number for User D r_{D}=4, and the non-coincidence number for User D s_{D}=2. The degree of coincidence R_{D} and the degree of non-coincidence S_{D} can then be calculated as follows:

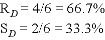

In this case, because the degree of non-coincidence S_{D} of User D exceeds the criterion value (e.g., 20%, when the coefficient α=0.3), the data generation unit 234 can decide that the movement history of User D does not satisfy the criterion and that Item C has not been utilized by User D in the target period.

In a case such as this, where it is decided that the reserver is not a user who has utilized the target item in the target period, the data generation unit 234 performs primary filtering for candidate users on the remaining users 20, as described in the first practical example. Then, for User E, who is specified as a candidate user, the degree of coincidence R_{E}=4/6=66.7% and the degree of non-coincidence S_{E}=0/6=0% between the histories satisfies the criterion, and the data generation unit 234 can therefore decide that User E has utilized Item C in the target period.

As another example, when the movement histories of two or more candidate users have a comparable level of correlation with the position history of the target item, the data generation unit 234 may preferentially decide that a user, from among the candidate users, who was the reserver for the target item as indicated by the reservation data, has utilized the target item. A user 20 scheduled to use an item 30 is highly likely to actually utilize that item 30 in accordance with the reservation, and thus such an approach makes it possible to decide on an actual utilization which is consistent with the actual state.

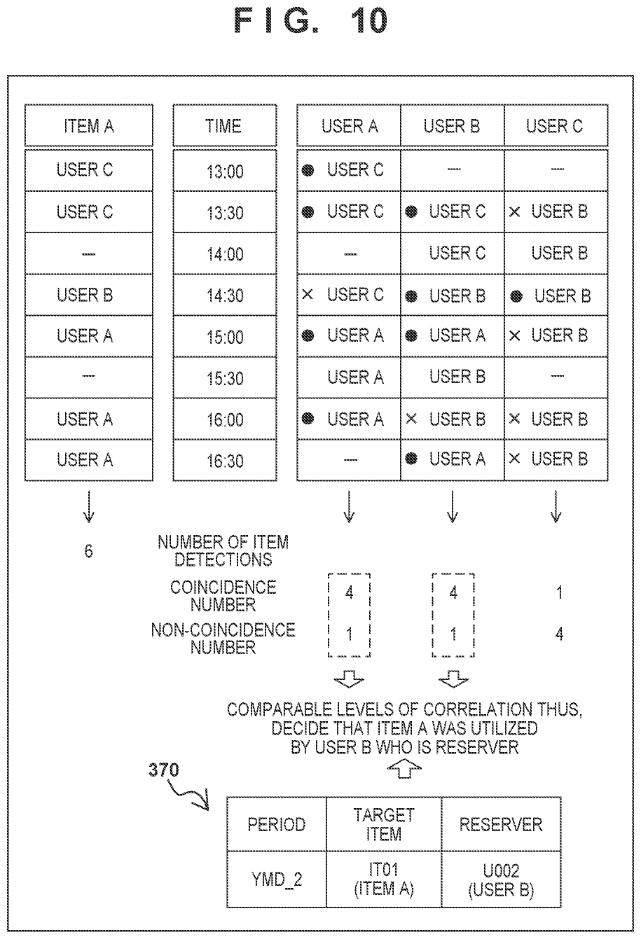

FIG. 10 is an explanatory diagram for explaining a decision on actual utilization based on a comparison of histories according to a third practical example. Here, the target item is Item A. A target period from 1:00 PM to 5:00 PM on a given date (YMD_2) is divided into a total of eight segments, and the start times of those segments are indicated in the time column. The position history of Item A is indicated to the left of the time column, and the movement histories of User A, User B, and User C are indicated to the right of the time column.

As primary filtering of candidate users, the data generation unit 234 identifies one or more users for which an area in the position history of the target item is included in the movement history, and compares the histories for those users. In the example in FIG. 10, Users A to C are identified as candidate users, and the degree of coincidence and degree of non-coincidence for these candidate users can be calculated as follows:

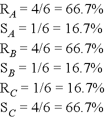

In this case, because both User A and User B satisfy the criterion, the data generation unit 234 refers to the reservation table 370.

The reservation data registered in the reservation table is partially indicated in the lower part of FIG. 10, and this reservation data indicates that Item A is scheduled to be utilized by User B during the target period. Accordingly, the data generation unit 234 may decide that Item A has been utilized by User B in the target period based on the correlation between the histories and the utilization reservation in the target period.

### <4. Flow of Processing>

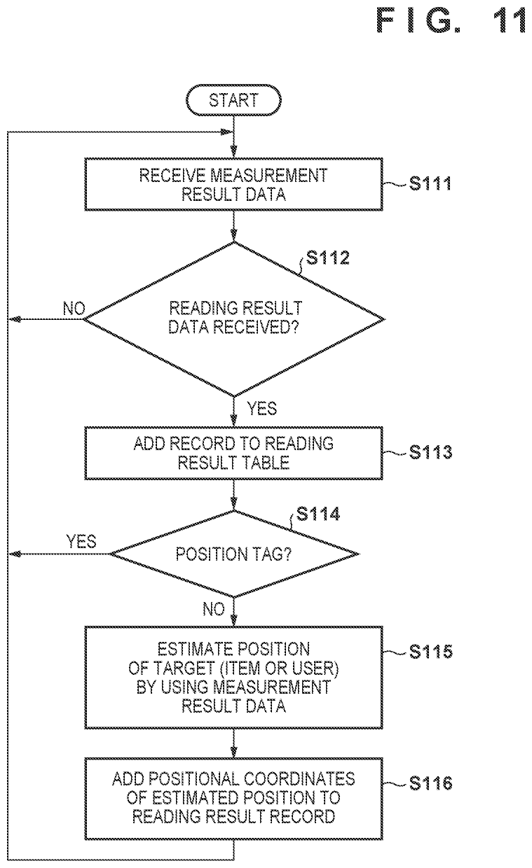

This section will describe several examples of processing flows that can be executed in the item management system 1, with reference to the flowcharts in FIGS. 11 to 14. Note that in the following descriptions, processing steps are indicated by an S, indicating “step”.

### <4.1. Position Estimation Processing>

FIG. 11 is a flowchart illustrating an example of the flow of the position estimation processing executed mainly by the position estimation unit 231 of the management server 200. The position estimation processing in FIG. 11 may be executed iteratively while at least one tag reader 100 is running in the item management system 1.

First, in S111, the position estimation unit 231 receives measurement result data transmitted from a tag reader 100 through the communication unit 210. In S112, the position estimation unit 231 stands by to receive reading result data from a tag reader 100 in parallel with the receiving of the measurement result data. When the reading result data is received from a tag reader 100, the sequence moves to S113. If no reading result data is received, the sequence returns to S111.

In S113, the position estimation unit 231 adds a record corresponding to the reading result data received from the tag reader 100 to the reading result table 350. The subsequent processing branches in S114 according to whether the received reading result data indicates that the tag ID of the position tag 40 has been read. If a tag ID of a position tag 40 has been read, the sequence returns to Sill. If a tag ID of an item tag 50 or a user tag 60 has been read rather than the position tag 40, the sequence moves to S115.

In S115, the position estimation unit 231 derives the position of the tag reader 100 at (or near, in terms of time) the reading time indicated by the received reading result data based on the amount of relative movement of the tag reader 100 from the point in time when the same tag reader 100 detected the position tag 40. The position derived here can be expressed as the sum of (i) the known positional coordinates of the position tag 40 detected at a given point in time and (ii) the amount of relative movement of the tag reader 100 from that point in time, which can be calculated from the measurement result data. The position estimation unit 231 then estimates that the detected target (the item 30 to which the item tag 50 is attached, or the user 20 carrying the user tag 60) is located at the derived position. Then, in S116, the position estimation unit 231 adds the positional coordinates of the estimated position of the detected target to the field for Coordinates 354 in the reading result record added to the reading result table 350 in S113. The sequence then returns to S111.

### <4-2. History Obtaining Processing>

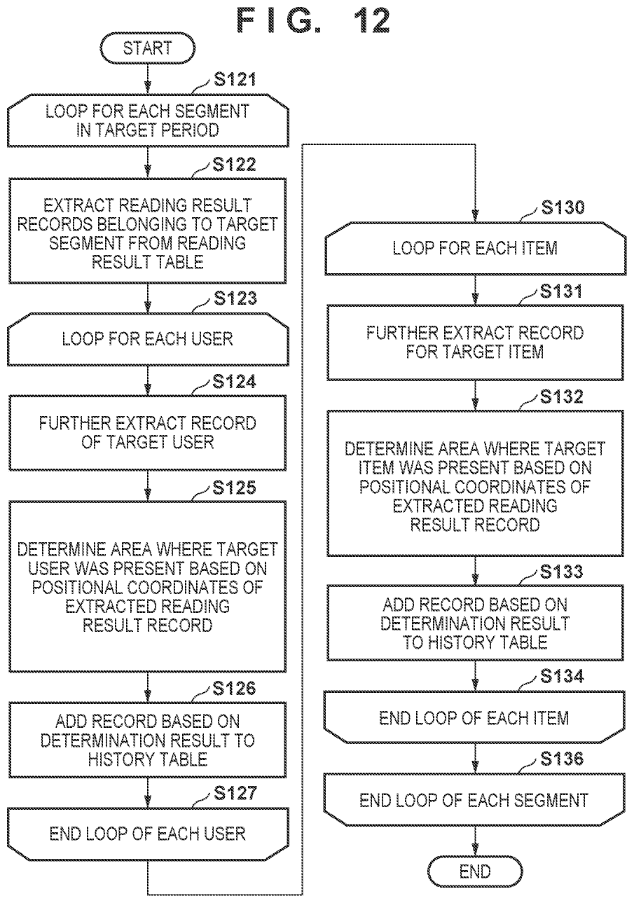

FIG. 12 is a flowchart illustrating an example of the flow of the history obtaining processing executed mainly by the history obtaining unit 232 of the management server 200. The history obtaining processing of FIG. 12 can be executed each time a period passes, such as several hours, half a day, or a day, for example.

As indicated in S121, the history obtaining processing is constituted by iterations (loops) in which the history is obtained for each of the segments included in the target period. A segment handled in a single iteration will be referred to here as a “target segment”. First, in S122, the history obtaining unit 232 extracts reading result records having reading times belonging to the target segment from the reading result table 350.

Then, in S123, the history obtaining unit 232 starts an iteration (sub-loop) of history obtainment that takes each of the plurality of users 20 as a target user. First, in S124, the history obtaining unit 232 further extracts a record indicating the tag ID of the user tag 60 of the target user from the reading result records obtained in S122. Then, in S125, the history obtaining unit 232 determines the area 10 in which the target user has existed in the target segment based on the values of the positional coordinates of the extracted reading result record (the detected position of the user tag 60). For example, the history obtaining unit 232 may determine that the target user has existed in an area 10 associated with a position tag 40 installed closest to the detected position of the user tag 60. Alternatively, the history obtaining unit 232 may determine that the target user has existed in a given area 10 when the detected position of the user tag 60 falls within a region of the area 10 determined by a simple definition of an area radius or by a definition of boundaries with a more complex shape. If a plurality of reading result records have been extracted in S124, the history obtaining unit 232 may determine, through a majority method, the area 10 in which the target user has existed based on the values of the positional coordinates in the reading result records. Then, in S126, the history obtaining unit 232 adds a history record, including the user ID of the target user, a time representative of the target segment, and the area ID or name of the area 10 determined in S125, to the history table 360. If it is determined that the obtainment of the movement history has ended for all the target users (S127), the sequence moves to S130.

In S130, the history obtaining unit 232 starts an iteration (sub-loop) of history obtainment that takes each of the plurality of items 30 as a target item. First, in S131, the history obtaining unit 232 further extracts a record indicating the tag ID of the item tag 50 of the target item from the reading result records obtained in S122. Then, in S132, the history obtaining unit 232 determines the area 10 in which the target item has existed in the target segment based on the values of the positional coordinates of the extracted reading result record (the detected position of the item tag 50). The method for determining the area here may be the same as the method described with reference to S125. Then, in S133, the history obtaining unit 232 adds a history record, including the item ID of the target item, a time representative of the target segment, and the area ID or name of the area 10 determined in S132, to the history table 360. If it is determined that the obtainment of the position history has ended for all the target items (S134), the sequence moves to S136.

In S136, the history obtaining unit 232 determines whether there is an unprocessed segment remaining within the target period, and if there is an unprocessed segment remaining, executes the processing steps of S122 to S134 for the next segment. If it is determined that the history obtainment has ended for all segments, the history obtaining processing of FIG. 12 ends.

### <4-3. Actual Utilization Generation Processing>

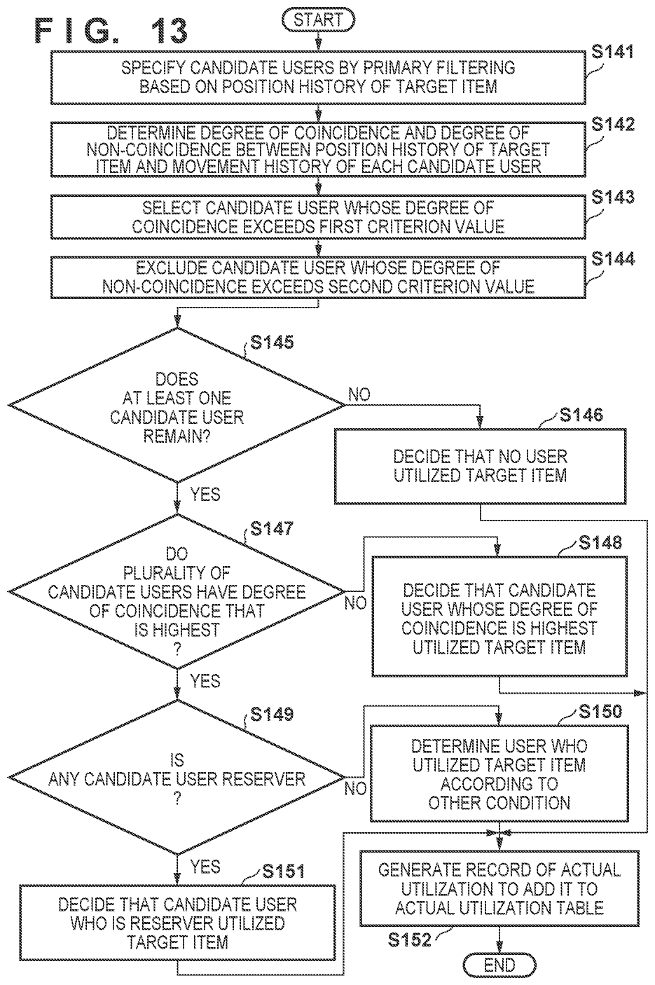

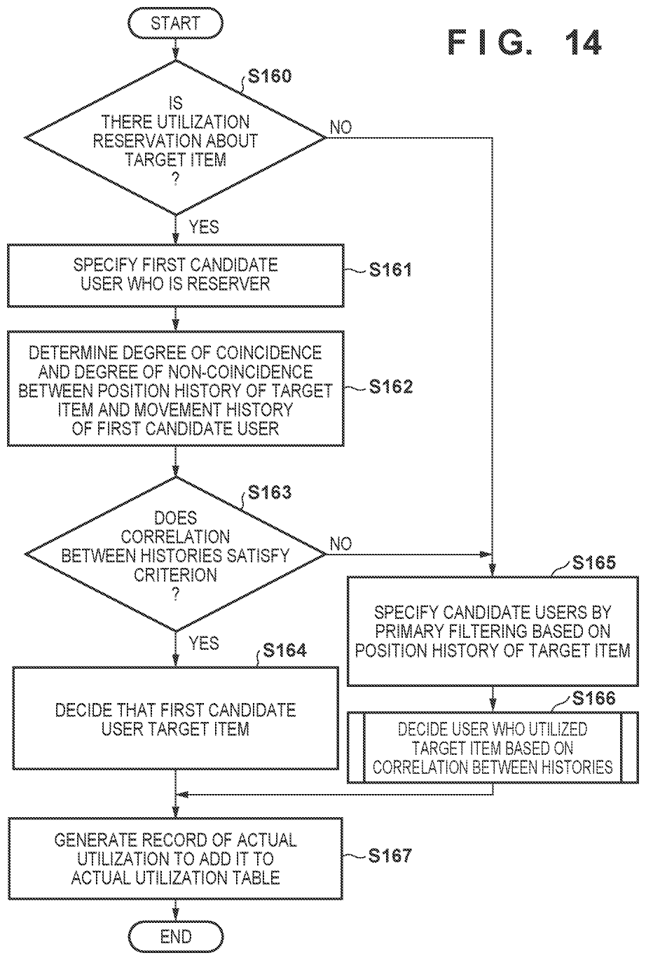

FIGS. 13 and 14 are flowcharts illustrating an example of the flow of the actual utilization generation processing executed mainly by the data generation unit 234 of the management server 200. The actual utilization generation processing can be executed on a regular basis each time the target period passes, for example, in the same manner as the history obtaining processing described above. Note that the actual utilization generation processing can be repeated for each item 30 managed by the system, but FIGS. 13 and 14 only illustrate the flow of processing for a single target item in order to simplify the descriptions.

In a first example, illustrated in FIG. 13, primary filtering of candidate users is performed before referring to the reservation data. In a second example, illustrated in FIG. 14, first, the reservation data is referenced, and a correlation between histories is determined for the reserver scheduled to utilize the target item.

### (1) First Example

In the first example in FIG. 13, first, in S141, the data generation unit 234 executes primary filtering based on the position history of the target item in the target period, and specifies candidates for users who have utilized the target item. For example, the data generation unit 234 specifies a maximum of M areas 10 described in the position history of the target item in the target period (e.g., M=5). The data generation unit 234 then specifies users 20, for which any specified area 10 is included in their movement histories for the target period, as candidate users.

Then, in S142, the data generation unit 234 determines the degree of coincidence and the degree of non-coincidence between the position history of the target item and the movement history of each of the candidate users specified in S141. Then, in S143, the data generation unit 234 selects a candidate user whose degree of coincidence determined in S142 exceeds a first criterion value. Then, in S144, the data generation unit 234 excludes, from the candidate users selected in S143, a candidate user whose degree of non-coincidence determined in S142 exceeds a second criterion value (that is lower than the first criterion value).

Zero, or any given number, of the selected candidate users remain as a result of the processing so far. In S145, the data generation unit 234 determines whether at least one selected candidate user remains. The sequence moves to S146 if no selected candidate users remain. On the other hand, if at least one selected candidate user remains, the sequence moves to S147.

In S146, the data generation unit 234 decides that no user 20 has utilized the target item in the target period. The sequence then moves to S152.

In S147, the data generation unit 234 determines whether there are a plurality of candidate users who have a degree of coincidence that is the highest, among the remaining candidate users. If only one candidate user has the degree of coincidence that is the highest, the sequence moves to S148. On the other hand, if a plurality of candidate users have the degree of coincidence that is the highest, the sequence moves to S149.

In S148, the data generation unit 234 decides that the candidate user having the highest degree of coincidence has utilized the target item in the target period. The sequence then moves to S152.

In S149, the data generation unit 234 refers to the reservation data for the target item in the target period, and determines whether the remaining candidate users include a reserver who was scheduled to utilize the target item. If the remaining candidate users do not include the reserver, the sequence moves to S150. On the other hand, if the remaining candidate users include the reserver, the sequence moves to S151.

In S150, the data generation unit 234 decides on the user who has utilized the target item, among the remaining plurality of candidate users 20, according to some other condition. For example, the data generation unit 234 may decide that it is “possible” that all of the remaining plurality of candidate users have utilized the target item in the target period. The sequence then moves to S152.

In S151, the data generation unit 234 decides that the target item has actually been utilized in the target period by the reserver who was scheduled to utilize the target item. The sequence then moves to S152.

In S152, the data generation unit 234 generates a record of the actual utilization of the target item for the target period according to the decision in S146, S148, S150, or S151, and adds the generated record to the actual utilization table 380.

### (2) Second Example

In the second example in FIG. 14, first, in S160, the data generation unit 234 decides whether there is a utilization reservation for the target item in the target period by referring to the reservation table 370. The sequence moves to S165 if there is no utilization reservation. The sequence moves to S161 if there is a utilization reservation.

In S161, the data generation unit 234 specifies the reserver indicated by the reservation record in the reservation table 370 as a first candidate user for which the history comparison should be performed preferentially. Then, in S162, the data generation unit 234 determines the degree of coincidence and the degree of non-coincidence between the position history of the target item and the movement history of the first candidate user. Next, in S163, the data generation unit 234 determines whether the correlation between the position history and the movement history, i.e., whether the degree of coincidence and the degree of non-coincidence determined in S162, satisfy a criterion. Here, the criterion may be, for example, that the degree of coincidence exceeds the above-described first criterion value and that the degree of non-coincidence does not exceed the above-described second criterion value. If the correlation between the histories satisfies the criterion, the sequence moves to S164. On the other hand, if the correlation between the histories does not satisfy the criterion, the sequence moves to S165.

In S164, the data generation unit 234 decides that the first candidate user, who is the reserver, has actually utilized the target item in the target period. The sequence then moves to S167.

In S165, the data generation unit 234 executes primary filtering based on the position history of the target item for the users 20 aside from the first candidate user, and specifies candidates for users who have utilized the target item. Here, the primary filtering may be performed in the same manner as in S141 of FIG. 13. Then, in S166, the data generation unit 234 determines a correlation between the movement history of each of the candidate users specified in S165 and the position history of the target item, and decides on the user 20 who has utilized the target item in the target period based on the determined correlation. Here, the decision may be made in the same manner as in S142 to S150 of FIG. 13, aside from the fact that the first candidate user has already been excluded. The sequence then moves to S167.

In S167, the data generation unit 234 generates a record of the actual utilization of the target item for the target period according to the decision in S164 or S166, and adds the generated record to the actual utilization table 380.

### 5. Conclusion

Thus far, various embodiments, practical examples, and variations of the technique according to the present disclosure have been described in detail with reference to FIGS. 1 to 14. According to the embodiments described thus far, in the item management system, a first wireless device is installed in each of a plurality of areas, a second wireless device is attached to an item, and a third wireless device is carried by each of a plurality of users. At least one reading apparatus attempts to read identification information from the wireless devices. Then, the position history of the items based on the results of the reading from the first and second wireless devices, and the movement history of each user based on the results of the reading from the first and third wireless devices, are obtained, and data indicating who has actually utilized the item is generated based on a comparison of the histories. According to this configuration, actual utilization data indicating the user who has actually used the item can be generated automatically without imposing a burden on the user, such as having to manually enter information in a ledger. Moreover, the location of the item and the movement of the users are tracked continuously while the item is being utilized, and thus the accuracy of the actual utilization data according to the embodiments described above will be enhanced compared to the existing method in which the actual utilization is ascertained indirectly from a history of lending and returning a key.

Additionally, according to the embodiments described above, reservation data indicating a reservation for utilization of the item is managed in a database, and the actual utilization data indicating the user who has actually utilized the item is generated based also on the reservation data. As an example, a comparison between the movement history of the reserver who was scheduled to utilize the item in a given period, and the position history of the item, may be performed preferentially. As a result, in many cases, it is possible to avoid repeating the history comparison for a large number of users, and the computational load required for generating the actual utilization data can therefore be reduced. As another example, when the movement histories of a plurality of users have a comparable level of correlation with the position history of the item, the user who is the reserver indicated by the reservation data may be preferentially decided on as the user who utilized the item. This makes it possible to eliminate ambiguity in the actual utilization and decide on the actual utilization that is consistent with the actual state with a high level of accuracy.

Additionally, according to the embodiments described above, the correlation between the position history of the item and the movement history of the user, which serves as the basis for deciding the actual utilization, may be expressed by the degree of coincidence between areas in which the item has existed in a given period on a per time frame basis and areas in which the user has existed in that period on a per time frame basis. According to this configuration, the correlation between the position history of the item and the movement history of the user can be evaluated objectively using quantitative numerical values, and the actual utilization of the item can be decided on accurately. The correlation between the position history of the item and the movement history of the user may further be expressed by a degree of non-coincidence between the areas in which an item has existed in a given period on a per time frame basis and the areas in which a user has existed in that period on a per time frame basis. This configuration makes it possible to eliminate the possibility of erroneously deciding that a user who has moved from the area where the item is present to a different area is the user who has utilized the item.

Additionally, according to the embodiments described above, each of at least one reading apparatus may be carried by a user and move among a plurality of areas. According to this configuration, a variety of wireless devices in the system can be detected successively as the users go about their normal activities, and the reading results can be collected. Accordingly, there is no additional workload on the users for obtaining position histories of the items and obtaining movement histories of the users.

Additionally, according to the embodiments described above, at least one reading apparatus is capable of measuring an amount of relative movement from a reference position. Additionally, the installation position of each of the first wireless devices is known. Then, the position of the item or the user is estimated based on (i) the amount of relative movement measured between the reading time of the identification information from the first wireless device and the reading time of the identification information from the second or third wireless device and (ii) the known installation position of that first wireless device. Which area the item or user has existed in may be determined based on this estimated position. According to this configuration, even if the reading apparatus is not in constant communication with an external system, such as a GPS satellite, the position of the item and the user can be estimated with a certain level of precision from the data accumulated over time. This makes it easy to both reduce the cost and power consumption of the apparatus, and accurately decide on the actual utilization.

Additionally, according to the embodiments described above, each wireless device is an RFID tag, and the reading apparatus reads information that is sent back from the RFID tag by utilizing the energy of electromagnetic waves emitted into the reading range. In this case, it is not necessary to install batteries and complex transmitters and receivers in the wireless devices attached to the items and the wireless devices carried by the users, and the configurations described above can be implemented at a low cost even in a situation where a large number of items are managed by the system and a large number of users are active.

According to the present invention, it will be possible to keep highly accurate records regarding utilization of items.

### 6. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An item management system comprising:
a plurality of first wireless devices installed in a plurality of areas, respectively;
a second wireless device attached to an item;
a plurality of third wireless devices carried by a plurality of users, respectively;
at least one reading apparatus that is capable of reading, from a wireless device, identification information stored in the wireless device;
a history obtaining unit configured to obtain a history of positions of the item based on results of reading of identification information from the first wireless devices and the second wireless device by the at least one reading apparatus, and obtain a history of movement of each user based on results of reading of identification information from the first wireless devices and the third wireless device by the at least one reading apparatus; and
a generation unit configured to generate actual utilization data associating the item with a user who has utilized the item based on comparison between the history of positions of the item and the history of movement of one or more users.

2. The item management system according to claim 1, wherein the item management system further comprises:
a reservation management unit configured to manage reservation data that indicates a reservation of utilization of the item in a database,
wherein the generation unit is configured to generate the actual utilization data further based on the reservation data.

3. The item management system according to claim 2, wherein the generation unit is configured to, in a case where the reservation data indicates that a first user has been scheduled to utilize the item during a certain period, compare a history of positions of the item during the period and a history of movement of at least the first user during the period.

4. The item management system according to claim 2, wherein the generation unit is configured to, in a case where histories of movement of a second user and a third user have a comparable level of correlation with a history of positions of the item, preferentially determine that the user who has been scheduled to utilize the item as indicated by the reservation data from among the second user and the third user is the user who has utilized the item.

5. The item management system according to claim 1, wherein the history of positions of the item indicates in which area the item has existed in time series, and
the history of movement of each user indicates in which area each user has existed in time series.

6. The item management system according to claim 5, wherein the generation unit is configured to
determine, for each of the one or more users, a degree of coincidence of areas in which the user has existed during a certain period per time frame basis with areas in which the item has existed during the period per time frame basis, and
decide the user who has utilized the item during the period based on the degree of coincidence determined for each user.

7. The item management system according to claim 6, wherein the generation unit is configured to
determine, for each of the one or more users, a degree of non-coincidence of areas in which the user has existed during a certain period per time frame basis with areas in which the item has existed during the period per time frame basis, and
decide that a user of which determined degree of non-coincidence exceeds a criterion value is not the user who has utilized the item during the period.

8. The item management system according to claim 1, wherein each of the at least one reading apparatus is carried by a user and moves among the plurality of areas.

9. The item management system according to claim 8, wherein the first wireless devices installed in respective areas have known installation positions,
the at least one reading apparatus is capable of measuring an amount of relative movement from a reference position, and
the item management system further comprises:
a position estimation unit configured to estimate a position of the item or each user at a second point in time based on the amount of relative movement measured by the at least one reading apparatus from a first point in time at which identification information has been read from the first wireless device to the second point in time point at which identification information has been read from the second wireless device or each third wireless device,
wherein the history obtaining unit is configured to determine in which area the item or each user has existed at the second point in time based on the position of the item or each user at the second point in time estimated by the position estimation unit.

10. The item management system according to claim 1, wherein the wireless device is a radio frequency identification (RFID) tag, and
the at least one reading apparatus is configured to emit an electromagnetic wave to a reading range and read information sent back from the wireless device utilizing energy of the electromagnetic wave.

11. A data generation method performed by an information processing apparatus, comprising:
communicating with at least one reading apparatus that is capable of reading, from a plurality of wireless devices, identification information stored in the wireless devices to receive results of reading of the identification information, the plurality of wireless devices including a plurality of first wireless devices installed in a plurality of areas, respectively, a second wireless device attached to an item, and a plurality of third wireless devices carried by a plurality of users, respectively;
obtaining a history of positions of the item based on results of reading of identification information from the first wireless devices and the second wireless device by the at least one reading apparatus;
obtaining a history of movement of each user based on results of reading of identification information from the first wireless devices and the third wireless device by the at least one reading apparatus; and
generating actual utilization data associating the item with a user who has utilized the item based on comparison between the history of positions of the item and the history of movement of one or more users.

12. An information processing apparatus comprising:
a communication unit configured to communicate with at least one reading apparatus that is capable of reading, from a plurality of wireless devices, identification information stored in the wireless devices, the plurality of wireless devices including a plurality of first wireless devices installed in a plurality of areas, respectively, a second wireless device attached to an item, and a plurality of third wireless devices carried by a plurality of users, respectively;
a history obtaining unit configured to obtain a history of positions of the item based on results of reading of identification information from the first wireless devices and the second wireless device by the at least one reading apparatus, and obtain a history of movement of each user based on results of reading of identification information from the first wireless devices and the third wireless device by the at least one reading apparatus; and
a generation unit configured to generate actual utilization data associating the item with a user who has utilized the item based on comparison between the history of positions of the item and the history of movement of one or more users.
